(19) United States
(12) Patent Application Publication
(10) Pub. No.: US 2021/0065282 A1
(43) Pub. Date: Mar. 4, 2021

(54) CUSTOMER-SERVICE PROVIDER MATCHING METHOD BASED ON OFFERS BY THE SERVICE PROVIDERS

(71) Applicants: Norman Colon-Casasnovas, Dorado, PR (US); Amanda Lopez-Iglesias, Dorado, PR (US)

(72) Inventors: Norman Colon-Casasnovas, Dorado, PR (US); Amanda Lopez-Iglesias, Dorado, PR (US)

(21) Appl. No.: 16/815,224

(22) Filed: Mar. 11, 2020

Related U.S. Application Data
(60) Provisional application No. 62/818,736, filed on Mar. 14, 2019.

(51) Int. Cl. G06Q 30/06; G06Q 30/02

(52) U.S. Cl. CPC G06Q 30/0639; G06Q 30/0619; G06Q 30/0283

(57) ABSTRACT

A customer service provider matching method based on offers by the service providers facilitates a link between customers and service providers to perform numerous tasks. Customers can ask for what he/she needs and wait for service provider offers to arrive. The system may include a customer side with a customer profile and service provider side with a service provider profile. The service provider may be able to interface with a live feed of categorized needed services with tools specific to make the offer to one or multiple customers. Users may be able to upload and share documents, pictures, videos as part of their profile, and may optionally have live chat and/or video if agreed by both parties to speak with the customer on the ongoing negotiation(s).

### CROSS-REFERENCE TO RELATED APPLICATION(S)

The present application is related to and claims priority to U.S. Provisional Patent Application No. 62/818,736 filed Mar. 14, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of service providing of existing art and more specifically relates to a customer service provider matching method based on offers by the service providers.

### RELATED ART

Many individuals seek services in modern society. People may have a difficult time locating individuals or companies for specific services. With a large range of variety and choices, people may be overwhelmed and lose a lot of time searching among many service providers. Resources may not be available for service providers looking to perform specific tasks. A suitable solution/method is desired.

U.S. Pat. No. 7,590,550 to Roy Schoenberg relates to a connecting consumers with service providers. The described Connecting consumers with service providers includes a request being received from a consumer of services to consult with a service provider having a service provider profile that satisfies at least some attributes in a set of attributes that define a suitable service provider; an available service provider satisfying at least some of the attributes in the set of attributes is identified; and a communication channel is provided to establish a communication between the consumer of services and the identified service provider

### SUMMARY OF THE INVENTION

In view of the foregoing disadvantages inherent in the known service providing art, the present disclosure provides a novel customer service provider matching based on offers by the service providers. The general purpose of the present disclosure, which will be described subsequently in greater detail, is to provide an efficient and effective customer service provider matching method based on offers by the service providers.

The present invention provides users with a method or program designed to link customers and service providers for various tasks. Effectively, the method allows inexperienced people to hire a service provider to put together, for example, furniture, build a computer, cut the yard, and numerous other tasks. Further, the method enables both customers and service providers to interface with one another with a live feed of categorized needed services with tools specific to make the offer to one or multiple customers. The application may offer a tangible means to enable a live chat or video for both parties to speak and a calendar based on offers accepted. The method may also feature a filter system that includes service categories and a distance limit.

A method of use for a customer service provider matching based on offers by the service providers is disclosed herein, in a preferred embodiment the method comprising: providing at least one electronic device capable of communicating within a network (or “internet of things”) via a software executable program; facilitating a real-time link between customers and service providers able to perform at least one task; at least one of the customers querying for what the customer needs are; waiting for a response-offer from the service providers to be communicated; responding to the response-offer received from the service providers; accepting and alternately declining the response-offer, when the response-offer is accepted facilitating the at least one task via a written communication from the at least one electronic device; negotiating the at least one task in exchange for money (or other valuable item); sharing of contact-information between the customers and the service providers to facilitate and perform the at least one task, (certain service providers can be blocked by the customer at will); renegotiating between the service providers and the customer provided both parties are willing. The at least one electronic device is capable of real-time-communicating within the network (or “internet of things”) between both parties. In some embodiments, this may incorporate live chat or video communication. Further, the at least one electronic device may be capable of sending documents, videos, and still-pictures within the network (or “internet of things”). The customer is able to interface with the at least one electronic device in an anonymous manner to post and request the at least one task. The software executable program utilizing the disclosed method may comprise a filter capable of limiting distance and service-categories, and has a calendar for scheduling. Within the software utilizing the disclosed method, the customer may be able to provide a customer-profile and the service provider is able to provide a service-provider-profile.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a customer service provider matching method based on offers by the service providers, constructed and operative according to the teachings of the present disclosure.

FIG. 1 is a perspective view of the customer service provider matching method based on offers by the service providers during an ‘in-use’ condition, according to an embodiment of the disclosure.

FIG. 2 is a flowchart of the customer service provider matching method based on offers by the service providers of FIG. 1, according to an embodiment of the present disclosure.

FIG. 3 is a flowchart view of a method of use for the customer service provider matching method based on offers by the service providers of FIG. 1, according to a preferred embodiment of the present disclosure.

FIG. 4 is a flowchart view of a method of use according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to service providing and more particularly to a customer service provider matching method based on offers by the service providers as used to improve the access, use and efficiency of services.

Generally, customer service provider matching method based on offers by the service providers facilitates a link between customers and service providers to perform numerous tasks. Customers can ask for what he/she needs and wait for service provider offers to arrive. The system utilizing the disclosed method may include a customer side with a customer profile and service provider side with a service provider profile. The service provider may be able to interface with a live feed of categorized needed services with tools specific to make the offer to one or multiple customers. Users may be able to upload and share documents, pictures, videos as part of their profile, and may also have live chat and/or video if agreed by both parties to speak with the customer on the ongoing negotiation(s). A calendar is included to sort through accepted offers via a filter system. The filter system can limit the distance and service categories being searched. The customer's side may be able to interface and include tools to properly request/post/ask for a needed service anonymously. This may include the ability to upload and share documents, pictures, videos as needed to properly define the needed service. Customers may or may not have live chat and/or video if agreed by both parties to speak with the worker on the ongoing negotiation(s). Once an offer is received the customer may accept or reject. If accepts the customer agrees to share needed information (address, phone number, etc.) and vice-versa so the service can be rendered. If the customer rejects the offer, there will be tools for renegotiation or block a specific service provider. The computerized system and electronic devices referred to herein include one or more processes such as a tracking module and a scheduling module for use with the calendar. Positioning means may also be employed. The system utilizing the disclosed method is able to access one or more databases. The components of the system and the web server may be integrated or distributed in various combinations as is known in the art.

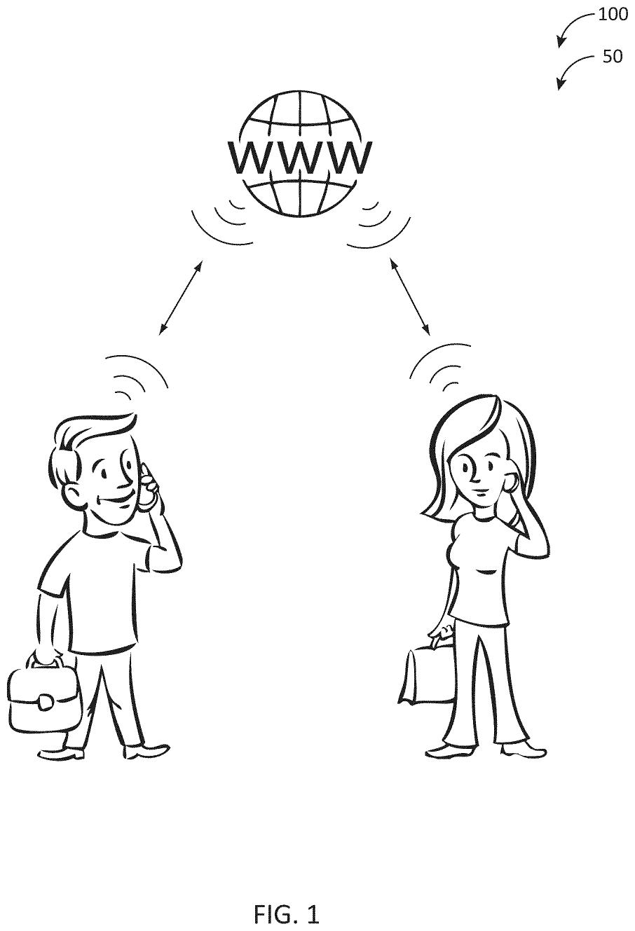

Referring now more specifically to the drawings by numerals of reference, there is shown in FIGS. 1-3, various views of a customer service provider matching method based on offers by the service providers 100. FIG. 1 is a perspective view of the customer service provider matching method based on offers by the service providers and method during an ‘in-use’ condition 50, according to an embodiment of the disclosure. Here, the customer service provider matching method based on offers by the service providers 100 may be beneficial for use by user(s) to make efficient the accessing and negotiation and rendering of services. As illustrated, the customer service provider matching method based on offers by the service providers 100 may include for a method of use (500): providing at least one electronic device capable of communicating within a network (or “internet of things”); facilitating a real-time link between customers and service providers able to perform at least one task; at least one of the customers querying for what the customer needs; waiting for a response-offer from the service providers to be communicated; responding to the response-offer received from the service providers; and accepting and alternately declining the response-offer, when the response-offer is accepted facilitating the at least one task via a written communication from the at least one electronic device. Communication is provided between devices of the customer and the service provider as is commonly known in the art. Electronic devices may comprise computers, cellular phones, tablets, smart appliances, smart cars and transportation systems, and the like.

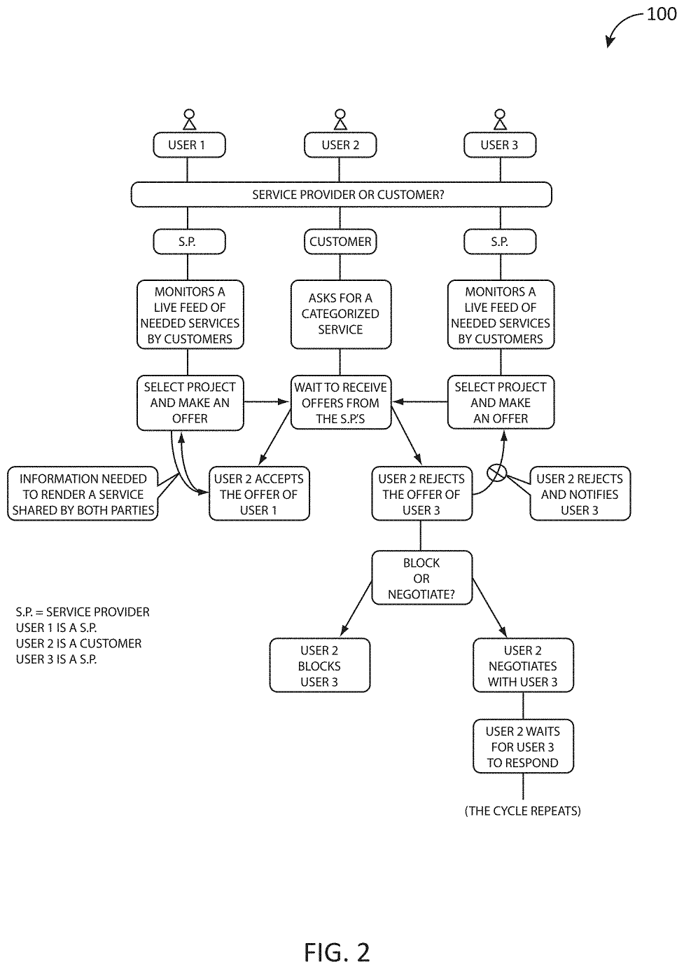

The method may further include negotiating the at least one task in exchange for money or other tangible value and sharing of contact-information between the customers and the service providers to facilitate and perform the at least one task is also enabled. Certain service providers can be blocked by the customer at will as shown in FIG. 2. The method 500 provides that renegotiation is able to be performed between the service providers and the customer (provided both parties of service providers and the customer are willing). The at least one electronic device is capable of real-time-communicating within the network (or “internet of things”) via live chat and/or via video. Communication between parties in this way may be optional. The at least one electronic device is capable of sending documents, still-pictures, and/or non-still-pictures (videos for example) within the network (or “internet of things”) via appropriate communication means.

The customer is able to interface with the at least one electronic device in an anonymous manner to post the at least one task and/or to request the at least one task. A filter may be used to limit distance and service-categories. The system 100 preferably further comprises a calendar. The customer is able to provide a customer-profile. Many options for use of the present system 100 on the electronic device are provided by the software application used.

FIG. 2 is a flowchart of the customer service provider matching method based on offers by the service providers 100 of FIG. 1, according to an embodiment of the present disclosure.

Here, we see Users 1, 2, and 3. User 1 is an S.P. (service provider); User 2 is a Customer; and user 3 is an S.P. User 1 (S.P.) is able to monitor a live feed of needed services by customers; to select a project and make an offer and user 2 is able to accept/reject the offer of user 1. If desired information can be shared. User 2 (customer) is able to ask for categorized service(s) and waits to receive an offer back which he/she can accept or reject as mentioned above. User 3 (S.P.) is able to monitor a live feed of needed services by customers and to select a project and make an offer. User 2 may reject the offer of user 3 and user 3 is then notified. User 2 is able to block or renegotiate with user 3 and the cycle can be repeated as needed.

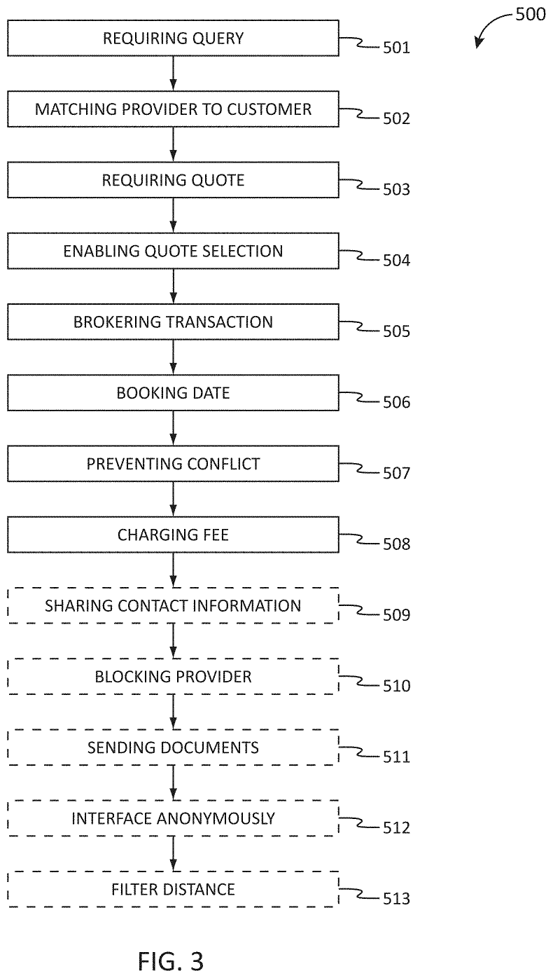

FIG. 3 is a flowchart view of a method of use for the customer service provider matching method based on offers by the service providers of FIGS. 1-2, according to an embodiment of the present disclosure. FIG. 3 is a flowchart view of a method of use for the customer service provider matching method based on offers by the service providers of FIGS. 1-2, according to an embodiment of the present disclosure. Method 500 may include step 501, requiring the customer to submit a query to the system for a service, the query comprising permission of access to the customer-profile-data and the customer-profile for the provider, a specified-service being requested, and a calendar-date request; step 502, matching at least one provider-profile to the customer-profile in response to the query; step 503, requiring the provider corresponding to the selected provider-profile to submit a quote for the service requested by the customer; step 504, enabling the customer to select from accepting the quote, declining the quote, and renegotiating the quote; step 505, brokering the transaction between the customer and the provider if the customer accepts the quote; step 506, booking a calendar-date corresponding to the service to be rendered; step 507, preventing other transaction for the provider to be booked during a conflicting time with the service to be rendered; and step 508, charging the commission fee to at least one of the customer and the provider if the transaction is successfully executed and booked. Further, method 500 may be modified by adding any combination of the following optional steps: step 509, sharing of contact-information between said customers and said service providers to facilitate and perform said at least one task; step 510, selectively blocking certain service providers as desired by a customer-user; step 511, sending documents within the network via the at least one electronic device; step 512, enabling the customer to interface with said at least one electronic device in an anonymous manner to request said specified-service, such that said provider cannot access customer-profile-data associated with said customer when said customer is accessing anonymously; and step 513, providing a filter able to limit a distance between matched providers and customers.

It should be noted that step 509-511 are optional steps and may not be implemented in all cases. Optional steps of method of use 500 are illustrated using dotted lines in FIG. 3 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using, back and forth communicating, and accessing, etc are taught herein.

An alternative (unillustrated) method of using the system 100 may include requiring the customer to submit a query to the system for a service, the query comprising permission of access to the customer-profile-data and the customer-profile for the provider, a specified-service being requested, and a calendar-date request; matching at least one provider-profile to the customer-profile in response to the query; requiring the provider corresponding to the selected provider-profile to submit a quote for the service requested by the customer; enabling the customer to select from accepting the quote, declining the quote, and renegotiating the quote; brokering the transaction between the customer and the provider if the customer accepts the quote; booking a calendar-date corresponding to the service to be rendered; preventing other transaction for the provider to be booked during a conflicting time with the service to be rendered; and charging the commission fee to at least one of the customer and the provider if the transaction is successfully executed and booked. Optional steps may further include sharing of contact-information between said customers and said service providers to facilitate and perform said at least one task.

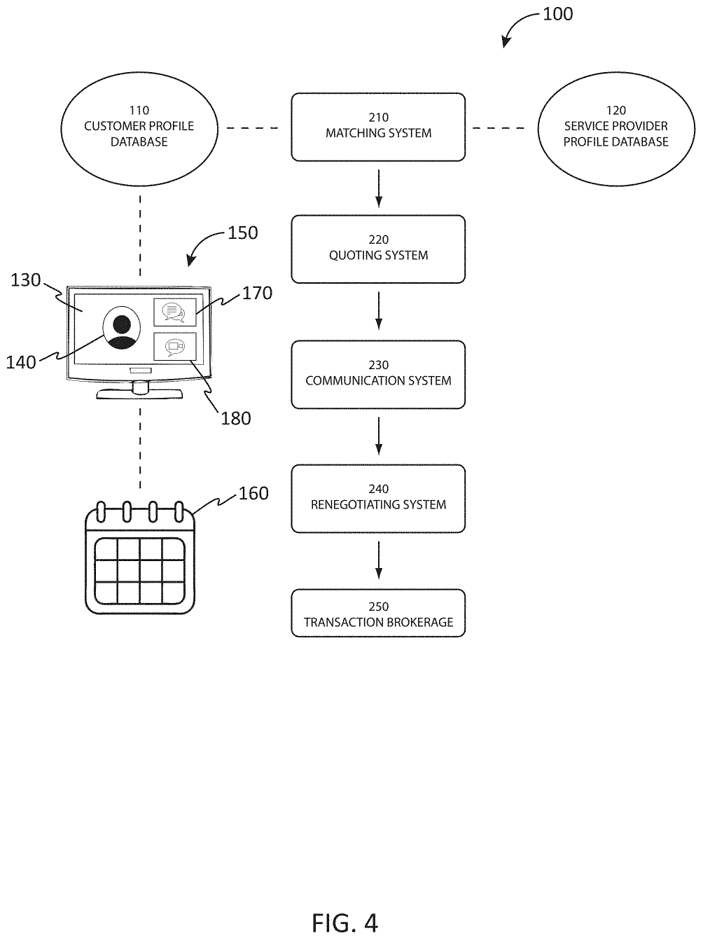

FIG. 4 is a diagram of the system 100 with the individual components enabling interaction of the customer and the service provider. System 100 may include database of customer-profile-data 110, such that the customer may be able to generate and customize their customer-profile 140, the customer-profile comprising customer-profile-data associated with that customer. System may also include database of provider-profiles 120, such that the provider-profiles contain service and provider data corresponding to a provider, with the provider being able to generate and customize their provider-profile. Further, system includes matching system 210, quoting system 220, communication system 230, renegotiating system 240, and transaction-brokerage 250. These systems may be used in succession or tandem to complete the process of providing a customer with a service. Matching system 210 is able to select at least one provider-profile from database of provider-profiles 120 in response to a query initiated by the customer. This may be accomplished using criteria obtained in the querie, information from the customer-profile-data, location information, and other data to best match the service-provider to the customer in the desired situation. Subsequently, quoting-system 220 enables the provider to submit a quote for a service to the customer in order for the provider-profile corresponding to the provider to be presented to the customer in response to the query once that provider is matched to the customer. Communication system 230 enables the provider may communicate and negotiate with the customer during this process. Renegotiating-system 240 enables the provider to submit a revised offer for an earlier-submitted quote in response to the query in such events that renegotiation is required or requested by the customer. Finally, transaction-brokerage 250 is able to arrange a transaction between a customer and a service-provider once the service fee has been successfully negotiated, and charges a commission fee when a transaction is successfully executed.

System may have a graphical user interface 130 viewable on at least one electronic device 150 whereby the customer can customize their customer-profile, communicate with other customers and providers, and submit queries, and whereby the provider can customize their provider-profile, communicate with other customers and providers, and submit quotes in response to queries. Included or in cooperation with in graphical user interface 130 may be calendar-interface 160, whereby executed transactions for a provider-service to be rendered are automatically logged into a provider-calendar corresponding to the associated provider, and whereby calendar-interface 160 prevents further transactions to be executed if a time and a date of the transaction conflict with those of a previously-executed transaction. At least one electronic device 150 may be able to display graphical user interface 130 and/or calendar-interface 160 to said customer and enable said customer to access and interact with said system. In some embodiments, system 100 may include two-way live-chat video interface 170 as an option for customers to communicate with service providers. Additionally, system 100 may include personal-messaging interface 180 to enable optional communication between users. A location-filter may be able to limit geographical distance between the customer and the provider during queries and matching, the location-filter limiting provider-profiles that be presented to the customer in response to the query to provider-profiles corresponding to providers which are within the specified geographical distance. The at least one electronic device 150 may be capable of sending documents within said network. A category-filter able to limit service categories of provider-profiles during queries and matching, the category-filter limiting provider-profiles that are presented to the customer in response to the query to provider-profiles matching at least one service category selected by the customer. Certain said service providers can be blocked by said customer at will. The customer may be able to interface with said at least one electronic device in an anonymous manner to request said specified-service, such that said provider cannot access customer-profile-data associated with said customer when said customer is accessing anonymously. System 100 may further comprise a filter able to limit a distance between matched providers and customers.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system able to match a customer with health care services and providers, the system comprising:
a database of customer-profile-data, the customer being able to generate and customize their customer-profile, the customer-profile comprising said customer-profile-data;
a database of provider-profiles, the provider-profiles containing service and provider data corresponding to a provider, the provider being able to generate and customize their provider-profile;
a matching system able to select at least one provider-profile from the database of provider-profiles in response to a query initiated by the customer;
a quoting-system, whereby the provider is required to submit a quote for a service to the customer in order for the provider-profile corresponding to the provider to be presented to the customer in response to the query;
a communication system whereby the provider may communicate and negotiate with the customer;
a renegotiating-system, whereby the provider is able to submit a revised offer for an earlier-submitted quote in response to the query;
a graphical user interface whereby the customer can customize their customer-profile, communicate with other customers and providers, and submit queries, and whereby the provider can customize their provider-profile, communicate with other customers and providers, and submit quotes in response to queries;
a transaction-brokerage, wherein the transaction-brokerage arranges a transaction between a customer and a service-provider, and charges a commission fee when a transaction is successfully executed;
a calendar-interface, whereby executed transactions for a provider-service to be rendered are automatically logged into a provider-calendar corresponding to the associated provider, and whereby the calendar-interface prevents further transactions to be executed if a time and a date of the transaction conflict with those of a previously-executed transaction; and
at least one electronic device able to display said graphical user interface to said customer and enable said customer to access and interact with said system.

2. The system of claim 1, wherein the communication system includes a two-way live-chat video interface.

3. The system of claim 1, wherein the communication system includes a personal-messaging interface.

4. The system of claim 1, further comprising a location-filter able to limit geographical distance between the customer and the provider, said location-filter limiting provider-profiles that be presented to the customer in response to the query to provider-profiles corresponding to providers which are within the specified geographical distance.

5. The system of claim 1, further comprising a category-filter able to limit service categories of provider-profiles, said category-filter limiting provider-profiles that are presented to the customer in response to the query to provider-profiles matching at least one service category selected by the customer.

6. A method of using the system of claim 1, the method comprising
requiring the customer to submit a query to the system for a service, the query comprising permission of access to the customer-profile-data and the customer-profile for the provider, a specified-service being requested, and a calendar-date request;
matching at least one provider-profile to the customer-profile in response to the query;
requiring the provider corresponding to the selected provider-profile to submit a quote for the service requested by the customer;
enabling the customer to select from accepting the quote, declining the quote, and renegotiating the quote;
brokering the transaction between the customer and the provider if the customer accepts the quote;
booking a calendar-date corresponding to the service to be rendered;
preventing other transaction for the provider to be booked during a conflicting time with the service to be rendered; and
charging the commission fee to at least one of the customer and the provider if the transaction is successfully executed and booked.

7. The method of claim 6, further including sharing of contact-information between said customers and said service providers to facilitate and perform said at least one task.

8. The method of claim 6, wherein certain said service providers can be blocked by said customer at will.

9. The method of claim 6, wherein the at least one electronic device is capable of sending documents within said network.

10. The method of claim 6, wherein said customer is able to interface with said at least one electronic device in an anonymous manner to request said specified-service, such that said provider cannot access customer-profile-data associated with said customer when said customer is accessing anonymously.

11. The method of claim 6, further comprising a filter able to limit a distance between matched providers and customers.
